(19) United States
(12) Patent Application Publication
(10) Pub. No.: US 2017/0284415 A1
(43) Pub. Date: Oct. 5, 2017

(54) FAN HOUSING AND ENGINE ASSEMBLY WITH FAN HOUSING

(71) Applicant: Rolls-Royce Deutschland Ltd & Co KG, Blankenfelde-Mahlow (DE)

(72) Inventor: Moritz WIRTH, Berlin (DE)

(21) Appl. No.: 15/463,489

(22) Filed: Mar. 20, 2017

(30) Foreign Application Priority Data
Apr. 1, 2016 (DE) 10 2016 105 957.9

(51) Int. Cl. F04D 29/54; F04D 29/66; F02K 3/06; F04D 19/00; F04D 29/52

(52) U.S. Cl. CPC F04D 29/541; F04D 19/002; F04D 29/526; F02K 3/06; F04D 29/664; F05D 2220/32

(57) ABSTRACT

A fan housing of a turbofan engine that forms an internal space surface at the inner side, delimiting a flow path through the fan of the turbofan engine radially outside, wherein the fan housing has a beginning of the housing that is arranged upstream. It is provided that a divergent cross-sectional surface extension of the flow path is realized by the internal space surface of the fan housing where it directly adjoins the beginning of the housing, and that the internal space surface of the fan housing is suited for continuously extending an inlet diffuser of an engine inlet, which is arranged upstream of the fan housing, into the area of the fan housing. The invention further relates to an engine assembly with a fan housing and an engine inlet.

### REFERENCE TO RELATED APPLICATION

This application claims priority to German Patent Application No. 10 2016 105 957.9 filed on Apr. 1, 2016, the entirety of which is incorporated by reference herein.

### BACKGROUND

The invention relates to a fan housing and to an engine assembly comprising a fan housing.

At the entry side, the turbofan engine has an engine inlet which supplies inflowing air to a fan. The fan is circumferentially surrounded by a fan housing. It is known to embody the engine inlet as a diffusor in order to decelerate the air flow in the axial direction in front of the fan. Further it is known, for example from US 2015/0128604 A1, to provide the inner surface of the fan housing with a constant diameter upstream of the fan, so that a cylindrical flow channel is provided directly in front of the fan. Such a cylindrical shape allows for the insertion of the fan into the engine and the fan housing from the front during the mounting of the engine. Here, the diameter of the fan housing is slightly larger than the largest diameter of the fan rotor, so that the fan rotor can be inserted into the fan housing. After the fan rotor has been positioned inside the fan housing, the engine inlet is connected to the fan housing upstream of the fan housing.

There is a need to further improve the flow conditions in front of the fan of a turbofan engine.

### SUMMARY

According to a first aspect of the invention a fan housing of a turbofan engine is provided that forms an internal space surface at the inner side, limiting a flow path through the fan of the turbofan engine radially outside. Such an internal space surface can also be referred to as a flow path boundary. It is formed by a wall contour of the fan housing. The fan housing has a beginning of the housing that is arranged upstream and that marks the beginning of the axial extension of the fan housing. It is provided that the internal space surface of the fan housing realizes a divergent cross-sectional surface extension of the flow path directly adjoining the beginning of the housing and is suited for continuously extending an inlet diffuser of an engine inlet, which is arranged upstream of the fan housing, into the area of the fan housing.

Thus, aspects of the invention are based on the idea to improve the flow conditions of the air that is flowing towards the fan by extending the inlet diffuser of the engine inlet into the area of the fan housing. Through the extension of the inlet diffuser, the diffusor can be embodied so as to be more smooth, which has the effect that the thickness of the boundary layer at the flow path boundary can be minimized. At that, the mass flow through the fan is increased.

For extending the inlet diffuser, the internal space surface of the fan housing extends in a divergent manner directly where it adjoins the beginning of the housing, so that the cross-sectional surface of the flow channel, which is surrounded by the internal space surface of the fan housing, increases in the axial direction behind the beginning of the housing. Here, the transition between the part of the input diffuser that is formed by the engine inlet and the part of the input diffuser that is formed according to the invention by the fan housing is formed to be continuously divergent, that is, it does not form an area in which the cross-sectional surface extends in a constant manner. At that, the transition is smooth in the mathematical sense, i.e. the internal surface also does not have any edges at the transition. The transition can also be configured in a curvature-constant manner, i.e. the internal surface in front of and behind the transition can have the same curvature.

According to one embodiment of the invention, the fan housing has a first area at the internal space surface and, connecting thereto in the axial direction, a second area, wherein the first area connects downstream to the beginning of the housing, and the second area adjoins the blade tips of the fan blades of the fan in the radial direction, with the divergent cross-sectional surface extension being formed in the first area.

Here, it can be provided that the cross-sectional surface first increases in the flow direction in the first area of the internal space surface where it adjoins the beginning of the housing, and then decreases again towards the second area of the internal space. For example, the divergent cross-sectional surface extension is provided through a shape of the first area of the internal space surface that is concave towards the flow path. Such a concave shape can for example be provided by a flat groove that forms the internal space surface in the first area, wherein such a groove ends at the beginning of the second area or in front of the same.

In a further embodiment of the invention, it is provided that the internal space surface has a first radius R1 at the beginning of the housing, the internal space surface has a first maximum radius R2 in the first area, and the fan blades of the fan have a second maximum radius R3, wherein it is provided that
the first radius R1 is larger than the second maximum radius R3,
the first maximum radius R2 is larger than the first radius R1, and
the first maximum radius R2 is larger than the second maximum radius R3. (R1>R3; R2>R1; R2>R3)

Here, the second maximum radius R3 corresponds to the largest radial extension of the blade tips of the fan blades. Since R3 is smaller than R1 and R2, it is easily possible to insert the fan rotor into the fan housing during the mounting process from the front side of the fan housing that is arranged upstream.

According to one embodiment of the invention, the housing components of the fan housing that are assigned to the first area are configured for the purpose of receiving fan fragments in the event that any fan blades break, and for avoiding that they penetrate the engine nacelle surrounding the fan housing in the outward direction. Thus, in the first area the fan housing forms a security area which is also referred to as a “fan case forward length” and which is structurally suited for receiving fan fragments. For this purpose, the fan housing is made of an aluminum alloy, for example. Here, it can be provided that housing components that belong to other areas of the fan housing, in particular housing components that belong to the second area or adjoin the same downstream, are configured for the purpose of receiving fan fragments in the event that any fan blades break, and for avoiding that they penetrate the engine nacelle in the outward direction, so that the mentioned security area is extended and is also realized in the second area and, if necessary, also other areas of the fan housing.

In a further embodiment of the invention, it is provided that the fan housing has a sound-absorbing panel (also referred to as the “forward acoustic panel”) where it adjoins the beginning of the housing, wherein the cross-sectional surface extension, which is divergent where it adjoins the beginning of the housing, is formed at least partially in the area of the panel. Here, the sound-absorbing panel is a component of the fan housing and is connected only to one or multiple structural housing components of the fan housing. Thus, in this embodiment variant, the inner wall of the panel forms the extension of the inlet diffuser. At that, the inlet diffuser can end in the area of the panel, or can extend beyond the same. The use of a sound-absorbing panel at the entrance of the fan housing is a measure for reducing engine noise.

According to one embodiment variant, at the upstream beginning of the housing, the fan housing has an attachment structure for attaching an engine inlet at the fan housing. The attachment structure can be embodied as a flange, for example.

In a second aspect of the invention, the invention relates to an engine assembly, which comprises:
a fan housing that forms an internal space surface at the inner side, delimiting a flow path through the fan of the turbofan engine radially outside, wherein the fan housing has a beginning of the housing that is arranged upstream, and
an engine inlet that is connected to the fan housing upstream and forms an inlet diffuser upstream of the connection between the fan housing and the engine inlet over a defined length,
wherein the inlet diffuser is continuously extended in the axial direction into the area of the fan housing.

According to a first embodiment of this invention variant, it is provided that a divergent cross-sectional surface extension is realized by the internal space surface of the fan housing directly where it adjoins the beginning of the housing, thus extending an inlet diffuser, which is formed by the engine inlet, into the area of the fan housing.

According to a second embodiment of this invention variant, it is provided that the engine assembly is formed in such a manner that
the fan housing comprises a first attachment structure for connection to the engine inlet at the beginning of the housing,
the engine inlet forms an inlet end that is arranged downstream,
at the inlet end, the engine inlet comprises a second attachment structure for connection to the fan housing,
wherein the first and second attachment structures that are connected to each other form a connection structure at which the inlet end of the engine inlet and the beginning of the housing of the fan housing are connected to each other,
the engine inlet forms an extension structure downstream of the inlet end, extending the inlet diffuser in the axial direction, and
in the assembled state, the extension structure extends downstream of the axial position of the connection structure, so that the inlet diffuser is extended in the axial direction into the area of the fan housing.

In one embodiment of the invention, the extension structure is formed by a sound-absorbing panel. In this invention variant, it protrudes from the engine inlet into the fan housing, as it were, wherein the panel forms the extension of the inlet diffuser with its inner wall.

According to a further embodiment, it is provided that the fan housing has a second area at the internal space surface that adjoins the fan blades of the fan in the radial direction, wherein the extension structure of the engine inlet extends in the axial direction maximally up to this second area. The extension structure, which can for example be formed by a sound-absorbing panel, as has already been explained, thus extends maximally up to the area of the internal space surface of the fan housing that adjoins the fan blades radially outside. However, it does not have to extend all the way to the second area and can also end upstream of this second area.

In one embodiment of the invention, the first attachment structure and the second attachment structure are flanges, respectively. In the connected state, they form a flange connection. Thus, according to this embodiment variant, the extension structure of the engine inlet extends in the axial direction to beyond the flange connection.

In a further aspect of the invention the invention relates to a turbofan engine with an inventive engine assembly.

### BRIEF DESCRIPTION OF THE DRAWINGS

The invention will be explained in more detail on the basis of exemplary embodiments with reference to the accompanying drawings in which:

FIG. 1 shows a simplified schematic sectional view of a turbofan engine;

FIG. 2 shows an assembly group of a turbofan engine that comprises an engine inlet and a fan housing according to the state of the art;

FIG. 3 shows a further assembly group of a turbofan engine that comprises an engine inlet and a fan housing according to the state of the art;

FIG. 4 shows an assembly group of a turbofan engine that comprises an engine inlet and a fan housing according to a first exemplary embodiment of the invention; and

FIG. 5 shows an assembly group of a turbofan engine that comprises an engine inlet and a fan housing according to a second exemplary embodiment of the invention.

### DETAILED DESCRIPTION

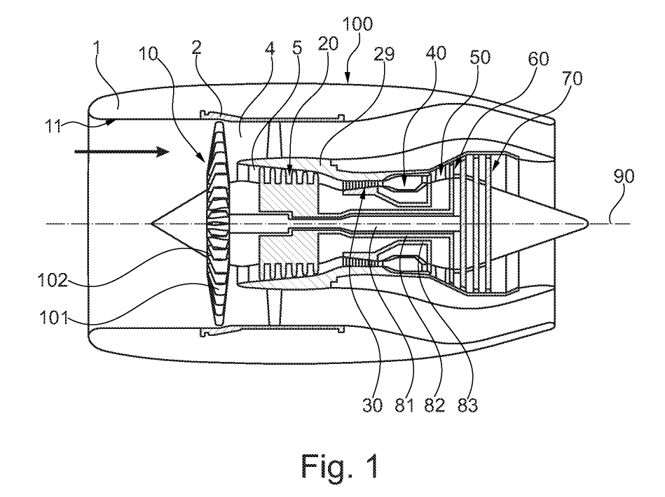

FIG. 1 schematically shows a turbofan engine 100 that has a fan stage with a fan 10 as the low-pressure compressor, a medium-pressure compressor 20, a high-pressure compressor 30, a combustion chamber 40, a high-pressure turbine 50, a medium-pressure turbine 60, and a low-pressure turbine 70.

The medium-pressure compressor 20 and the high-pressure compressor 30 respectively have a plurality of compressor stages that respectively comprise a rotor stage and a stator stage. The turbofan engine 100 of FIG. 1 further has three separate shafts, a low-pressure shaft 81 which connects the low-pressure turbine 70 to the fan 10, a medium-pressure shaft 82 which connects the medium-pressure turbine 60 to the medium-pressure compressor 20, and a high-pressure shaft 83 which connects the high-pressure turbine 50 to the high-pressure compressor 30. However, this is to be understood to be merely an example. If, for example, the turbofan engine has no medium-pressure compressor and no medium-pressure turbine, only a low-pressure shaft and a high-pressure shaft would be present.

The turbofan engine 100 has an engine nacelle 1 that forms an engine inlet 11 at the entry side, supplying inflowing air to the fan 10. The fan 10 has a plurality of fan blades 101 that are connected to a fan disc 102. Here, the annulus of the fan disc 102 forms the radially inner delimitation of the flow path through the fan 10. Radially outside, the flow path is delimited by the fan housing 2. Upstream of the fan-disc 102, a nose cone is arranged.

The turbofan engine 100 has an engine nacelle 1 that forms an engine inlet 11 at the entry side that supplies inflowing air to the fan 10. The fan 10 has a plurality of fan blades 101 that are connected to a fan disc 102. At that, the annulus of the fan disc 102 forms the radially inner limitation of the flow path through the fan 10. Radially outside, the flow path is delimited by a fan housing 2. A nose cone is arranged upstream of the fan disc 102.

Behind the fan 10, the turbofan engine 100 forms a secondary flow channel 4 and a primary flow channel 5. The primary flow channel 5 leads through the core engine which comprises the medium-pressure compressor 20, the high-pressure compressor 30, the combustion chamber 40, the high-pressure turbine 50, the medium-pressure turbine 60, and the low-pressure turbine 70. At that, the medium-pressure compressor 20 and the high-pressure compressor 30 are surrounded by a circumferential housing 29 which forms an annulus surface at the internal side, delimitating the primary flow channel 5 radially outside. Radially inside, the primary flow channel 5 is delimitated by corresponding rim surfaces of the rotors and stators of the respective compressor stages, or by the hub or by elements of the corresponding drive shaft connected to the hub.

The described components have a common symmetry axis 90. The symmetry axis 90 defines an axial direction of the turbofan engine. A radial direction of the turbofan engine extends perpendicularly to the axial direction.

In the context of the present invention, the embodiment of the fan housing 2 and of the engine inlet 11 are of particular importance, as will be explained in the following.

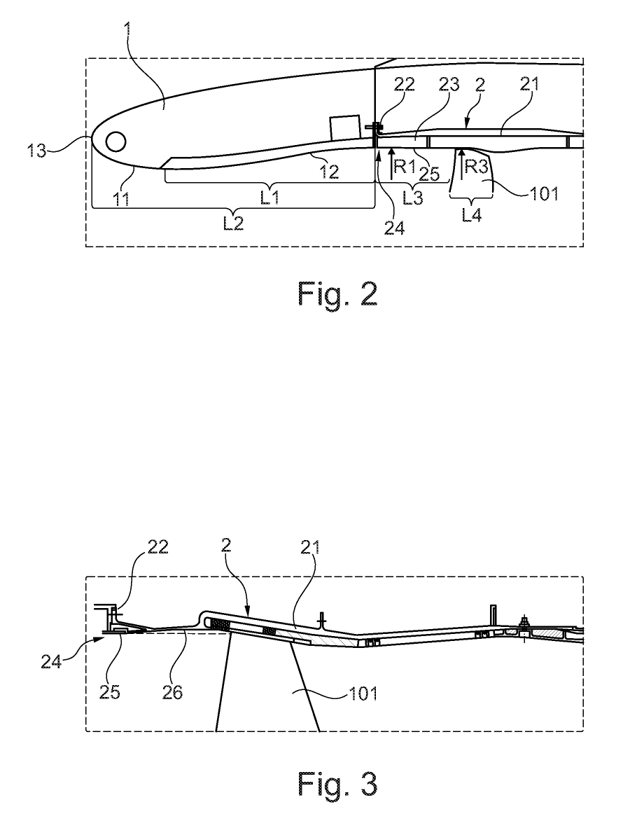

To provide a better understanding of the invention, at first two fan housings according to the state of the art are described based on FIGS. 2 and 3.

FIG. 2 shows a section of an engine nacelle 1 that comprises an engine inlet 11 and a fan housing 2. The engine inlet 11 comprises inlet lips 13 at the entrance of the engine. Connecting to the same, the engine inlet 11 forms an inlet diffuser 12 in which the cross-sectional surface of the flow path, which is delimited by the inlet diffuser 12 radially outside, increases continuously. Here, the inlet diffuser 12 is formed by the inner wall of the engine inlet 11.

In FIG. 2, the length of the engine inlet 11 is indicated by L2, and the length of the inlet diffuser is indicated by L1.

The fan housing 2 comprises structural housing components 21 that are shown only in a schematic manner as their detailed structure is not of importance when it comes to the invention. At the inner side, the fan housing 2 forms an internal space surface 25 that delimitates the flow path through the turbofan engine in the area of the fan housing 2 radially outwards. In the axial direction, the internal space surface 25 is divided into two areas that correspond to the lengths L3 and L4 and will be referred to as L3 and L4 in the following. The first area L3 extends from an upstream beginning of the housing 24 of the fan housing 2 to the second area L4. The second area L4 is characterized by its radially outward position adjoining the fan blades 101 of the fan.

In the first area L3, the internal space surface 25 has a constant diameter or radius R1, i.e. the internal space surface 25 is formed in a cylindrical manner in this area L3. At the blade tips, the fan blades 101 have a maximum radius R3, wherein it is provided that R1 is larger than R3. This makes it possible to insert the completely mounted fan 10 (cf. FIG. 1) into the fan housing 2 from the front at a later point in time in the course of the manufacture of the engine. Subsequently, the engine inlet 11 is connected to the fan housing 2, which may for example be realized by means of a flange connection 22. The flange connection 22 is also referred to as an A1 connection.

It should be noted that the housing components of the fan housing 2 that belong to the first area L3 are structurally embodied in such a manner that they are suited for receiving fan fragments in the event that a fan blade breaks and for avoiding that they penetrate the engine nacelle 1 in an outward direction. The first area L3 is necessary for this purpose, so that it may not be omitted. The first area is also referred to as the “fan case forward length”. Of course, also the other areas of the fan housing 2 can be configured in such a manner that they can receive fan fragments in the event that a fan blade breaks.

Further, it should be noted that the first area L3 of the internal space surface 25 may have a sound-absorbing panel 23. Typically, it is formed so as to be directly adjoining the beginning of the housing 24.

A fan housing 2 with an internal space surface 25 that is embodied upstream in the form of a cylinder is realized in Rolls-Royce engines BR710, BR715, BR725 and in Trent 900, for example.

FIG. 3 shows a variation on the fan housing of FIG. 2, where, just like in FIG. 2, the internal space surface of the fan housing is formed in such a manner that a cylindrical internal space surface 25 with a constant diameter or radius connects to the beginning of the housing 24. However, this cylindrical area 25 does not extend all the way to the area that radially adjoins the fan blades 101. Thus, an area with an internal space surface 26 is additionally provided, which connects to the cylindrical area 25 in the axial direction and in which the internal space surface 26 is embodied as a flat groove where the radius of the internal space surface 26 increases and then decreases again. The engine IAE V2500 A5 comprises such a fan housing.

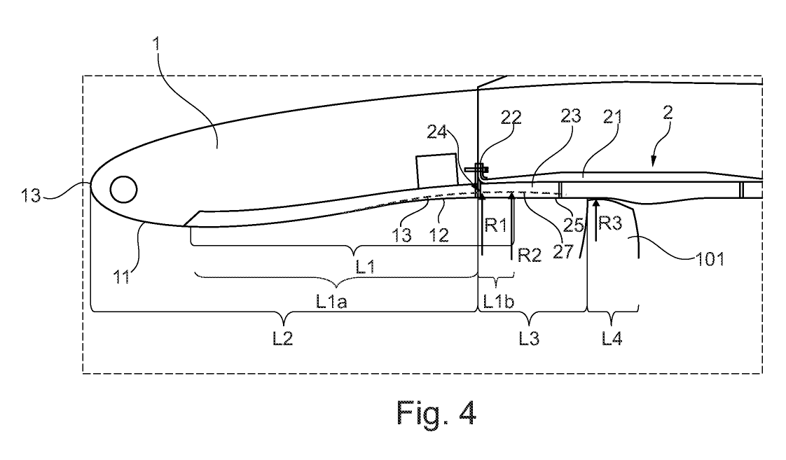

FIG. 4 shows a first exemplary embodiment of the invention. An engine nacelle 1 has an engine inlet 11 and a fan housing 2. The engine inlet 11 comprises inlet lips 13 at the entrance of the engine. Connecting to the same, the engine inlet 11 forms an inlet diffuser 13 inside of which a cross-sectional surface of the flow path, which is delimited by the inlet diffuser 12 radially outside, increases in a continuous manner.

The fan housing 2 comprises structural housing components 21. At the inner side, it forms an internal space surface 27 that delimits the flow path through the turbofan engine in the area of the fan housing 2 radially outside. The fan housing 2 comprises a beginning of the housing 24 that is arranged upstream. Like in FIG. 2, the internal space surface 27 is divided into two areas in the axial direction that correspond to the lengths L3 and L4 and are referred to as L3 and L4. The first area L3 extends from the beginning of the housing 24 of the fan housing 2 that is arranged upstream to the second area L4. The second area L4 is characterized by its radially outside position adjoining the fan blades 101 of the fan.

The connection between the engine inlet 11 and the fan housing 2 is realized by means of a connection structure 22, for example a flange connection that is also referred to as an A1 connection. The connection structure 22 connects an inlet end of the engine inlet 11 and the beginning of the housing 24 of the fan housing 2.

In contrast to FIG. 2, it is provided that a divergent cross-sectional surface extension (in other words: a divergent course of the cross-sectional area) of the flow path is realized in the internal space surface 27 of the fan housing 2 where it directly adjoins the beginning of the housing 24. In this way, the internal space surface forms a continuous extension of the inlet diffuser 13 of the engine inlet 11. In contrast to the state of the art that is shown in FIGS. 2 and 3, the inlet diffuser is embodied as an extended inlet diffuser that has an area 13 which is realized in the engine inlet 13, as well as an area 27 that extends into the fan housing 2.

Thus, the inlet diffuser has a total length L1 that comprises two partial areas L1a and L1b, wherein the partial area L1a is delimited by the internal space surface 13 of the inlet diffuser, and the partial area 1b is delimited by the internal space surface 27. Accordingly, the partial area L1a extends upstream of the connection structure 22. The partial area L1b extends downstream of the connection structure 22. The length of the engine inlet 11 is indicated by L2.

It should be noted that, to provide a better explanation of the invention in FIG. 4, the internal space surfaces 12, 25 are also shown according to the state of the art as it is shown in FIG. 2. By way of comparison, the extension of the inner wall 13, 27 according to the invention is shown by dashed lines.

According to FIG. 4, the divergent inner wall area L1b is formed in the section of the first area L3 that adjoins the beginning of the housing 24. Thus, the divergent cross-sectional surface extension is formed at the beginning of the first area L3 as viewed in the flow direction. Here, the cross-sectional surface at first increases in the flow direction in the first area L3 where it adjoins the beginning of the housing 24 (up to the end of the area L1b), and then decreases again towards the second area L4. For this purpose, the first area L3 has a concave shape towards the flow path. It is formed by a flat groove, for example.

The internal space surface 27 has a first radius R1 at the beginning of the housing 24, and has a first maximum radius R2 in the first area L3. At that, the maximum radius R2 is located at the end of the area L1b, thus it corresponds to the largest cross-sectional surface of the flow path. Further, the fan blades 101 of the fan have a second maximum radius R3. It is provided that the first radius R1 is larger than the second maximum radius R3, and that the first maximum radius R2 is larger than both the first radius R1 and the second maximum radius R3. In this manner, it is ensured that during mounting the completely mounted fan can be inserted into the fan housing from the front.

It should be noted that the fan housing 2 according to the embodiment of FIG. 4 has a sound-absorbing panel 23 adjoining the beginning of the housing 24. Accordingly, the divergent extension of the cross-sectional surface is formed at least partially in the area of the panel 23. However, this is to be understood merely as an example. If no such panel 23 is present, the divergent extension of the cross-sectional surface is formed by other structures of the inner wall of the fan housing 2. It is also to be understood that it can be provided in alternative embodiments that the divergent cross-sectional surface extension extends across larger axial areas of the panel 23, or even beyond them.

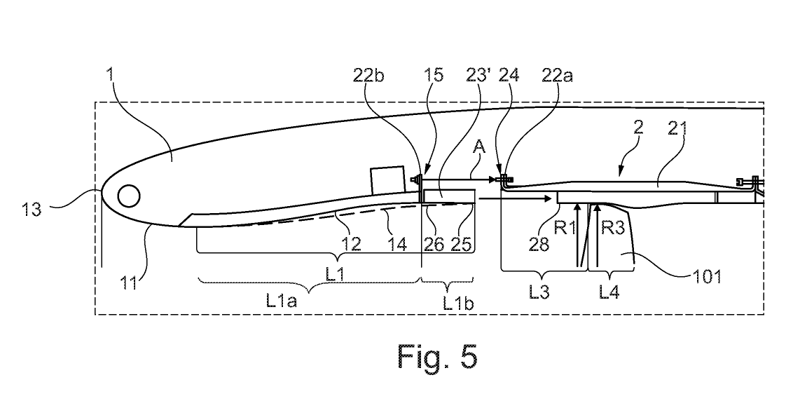

FIG. 5 shows another exemplary embodiment of the invention in which a diffusor is realized which is expanded due to the fact that it extends continuously all the way into the fan housing 2. The difference to the exemplary embodiment of FIG. 4 is that the structure that is arranged inside the fan housing 2 and that provides the extension of the diffusor is formed by a part of the engine inlet 11.

It is provided that the fan housing 2 has a first attachment structure 22a for connection to the engine inlet 11 at the beginning of the housing 24. The engine inlet 11 has an inlet end 15 that is arranged downstream. At the inlet end 15, a second attachment structure 22b for connection to the fan housing 2 is provided. Here, the first and second attachment structures 22a, 22b that are connected to each other form a connection structure (corresponding to the connection structure 22 of FIG. 4) at which the inlet end 15 of the engine inlet 11 and the beginning of the housing 24 of the fan housing 2 are connected to each other.

The engine inlet 11 also forms an inlet diffuser 14 over a defined length L1a upstream of the attachment structure 22b. Moreover, it is provided that the engine inlet 11 forms an extension structure 23′ downstream of the inlet end 15, extending the inlet diffuser 14 in the axial direction and having the length L1b. This extension structure 23′ extends downstream of the second attachment structure 22b. It forms an internal space surface 26 that realizes a divergent cross-sectional surface extension of the flow path. In this manner, in the mounted state, the inlet diffuser is continuously extended in the axial direction into the area of the fan housing 2, wherein the inlet diffuser with the total length L1 is formed by the internal space surfaces 14 and 26, or the lengths L1a and L1b.

Also in FIG. 5, to provide a better explanation of the invention, the internal space surfaces 12, 25 are shown according to the state of the art as it is explained in connection to FIG. 2. By way of comparison, the inner wall extension 14, 26 according to the invention is indicated by a dashed line.

In the exemplary embodiment of FIG. 5, the extension structure 23′ is formed by a sound-absorbing panel. However, this is not necessarily the case. Principally also any another structure with an internal space surface that is formed in a divergent manner can connect to the inlet end 15.

The extension structure 23′ of the engine inlet 11 extends in the axial direction maximally up to the second area L4 of the fan housing 2 that adjoins the fan blades 101 of the fan in the radial direction. However, as shown in FIG. 5, the extension structure does not have to extend that far and can end upstream of the second area L4.

In FIG. 5, the internal space surface of the fan housing 2 is indicated by the reference sign 28. However, it is not formed in a divergent manner in the exemplary embodiment of FIG. 5, since the divergence for extending the inlet diffuser is provided by the extension structure 23′. Accordingly, upstream of the fan, the internal space surface 28 has a radius R1 that is constant and at the same time larger than the largest radius R3 of the fan blades 101.

During mounting, the engine inlet 11 and the fan housing 2 are displaced with respect to each other in the direction of the arrow A. The first attachment structure 22a and the second attachment structure 22b are respectively flanges and form a flange connection (corresponding to the flange connection 22 of FIG. 4) in the connected state. The extension structure 23′ extends in the axial direction into the fan housing 2 to beyond the flange connection, where it forms an extension of the inlet diffuser.

For all described exemplary embodiments of the invention, the extension of the inlet diffuser in the axial direction into the area of the fan housing is formed in such a manner that the inlet diffuser has a continuously divergent cross-sectional surface extension in the transitional area between the engine inlet and the fan housing. Thus, the diameter or radius of the diffusor increases in a continuous manner without forming plateaus of a constant diameter. At that, the inner wall of the diffusor is also smooth and has no edges in the transitional area between the area of the inlet diffuser that is realized in the engine inlet and the area of the inlet diffuser that is realized in the fan housing.

At the same time, is should be understood that the divergence in the area of the inlet diffuser that is realized in the fan housing 2 does not have to be embodied very strongly. For example, the deviation from the cylindrical extension of the internal space surface adjoining the beginning of the housing 24 is between 0.5° and 4°, in particular between 1° and 2°.

The invention is not limited in its design to the exemplary embodiments described above, which are to be understood merely as examples. For instance, the extension and degree of divergence of the inlet diffuser as well as the described structure of the fan housing and engine inlet are to be understood to be merely examples.

It is furthermore pointed out that the features of the individually described exemplary embodiments of the invention can be combined in various combinations with one another. Where areas are defined, they include all the values within these areas and all the sub-areas falling within an area.

What is claimed is:

1. A fan housing of a turbofan engine that forms an internal space surface at the inner side, delimiting the flow path through the fan of the turbofan engine radially outside,
wherein the fan housing comprises a beginning of the housing that is arranged upstream,
wherein a divergent cross-sectional surface extension of the flow path is realized by the internal space surface of the fan housing where it directly adjoins the beginning of the housing, and
wherein the internal space surface of the fan housing is suited for continuously extending the inlet diffuser of an engine inlet, which is arranged upstream of the fan housing, into the area of the fan housing.

2. The fan housing according to claim 1, wherein the fan housing comprises a first area at the internal space surface, and a second area adjoining thereto in the axial direction, wherein the first area joins downstream to the beginning of the housing, and the second area is in the radial direction adjacent to the blade tips of the fan blades of the fan, and wherein the divergent cross-sectional surface extension is formed in the first area.

3. The fan housing according to claim 2, wherein the cross-sectional surface of the flow path at first increases in the flow direction in the first area of the internal space surface adjoining the beginning of the housing, and decreases again towards the second area of the internal space surface.

4. The fan housing according to claim 3, wherein the divergent cross-sectional surface extension is provided by a shape of the first area of the internal space surface that is concave towards the flow path.

5. The fan housing according to claim 2, wherein the internal space surface has a first radius at the beginning of the housing, has a first maximum radius in the first area, and in that the fan blades of the fan have a second maximum radius, wherein
a) the first radius is larger than the second maximum radius, and
b) the first maximum radius is larger than both the first radius and the second maximum radius.

6. The fan housing according to claim 2, wherein the housing components of the fan housing that belong to the first area are configured for receiving fan fragments in the event that a fan blade breaks, and for avoiding that they penetrate the engine nacelle surrounding the fan housing in an outward direction.

7. The fan housing according to claim 1, wherein the fan housing has a sound-absorbing panel adjoining the beginning of the housing that is connected only to one or multiple structural housing components of the fan housing, wherein the cross-sectional surface extension that is divergent where it adjoins the beginning of the housing is formed at least partially in the area of the panel.

8. The fan housing according to claim 1, wherein the fan housing has an attachment structure for connecting an engine inlets at the fan housing at the beginning of the housing that is arranged upstream.

9. The fan housing according to claim 8, wherein the attachment structure is formed as a flange.

10. An engine assembly, comprising:
a fan housing that forms an internal space surface at the inner side, delimiting a flow path through the fan of the turbofan engine radially outside, wherein the fan housing has a beginning of the housing that is arranged upstream, and
an engine inlet that is connected upstream to the fan housing and that forms an inlet diffuser upstream of the connection between the fan housing and engine inlet over a defined length,
wherein the inlet diffuser is continuously expanded in the axial direction into the area of the fan housing.

11. The engine assembly according to claim 10, wherein a divergent cross-sectional surface extension of the flow path is realized by the internal space surface of the fan housing where it directly adjoins the beginning of the housing, and the internal space surface thus extends the inlet diffuser, which is formed by the engine inlet, into the area of the fan housing.

12. The engine assembly according to claim 11, wherein the fan housing comprises a first area at the internal space surface, and a second area adjoining thereto in the axial direction, wherein the first area joins downstream to the beginning of the housing, and the second area is in the radial direction adjacent to the blade tips of the fan blades of the fan, and wherein the divergent cross-sectional surface extension is formed in the first area, wherein the cross-sectional surface at first increases in the flow direction in the first area of the internal space surface adjoining the beginning of the housing, and decreases again towards the second area of the internal space surface.

13. The engine assembly according to claim 12, wherein the internal space surface has a first radius at the beginning of the housing, has a first maximum radius in the first area, and in that the fan blades of the fan have a second maximum radius, wherein
a) the first radius (R1) is larger than the second maximum radius, and
b) the first maximum radius is larger than both the first radius and the second maximum radius.

14. The fan housing according to claim 11, wherein the fan housing has a sound-absorbing panel adjoining the beginning of the housing, which is connected only to one or multiple structural housing components of the fan housing, wherein the cross-sectional surface extension that is divergent where it adjoins the beginning of the housing is formed at least partially in the area of the panel.

15. The engine assembly according to claim 10, wherein
the fan housing comprises a first attachment structure for connection to the engine inlet at the beginning of the housing,
the engine inlet forms an inlet end that is arranged downstream,
the engine inlet comprises at the inlet end a second attachment structure for connection to the fan housing,
wherein the first and second attachment structures that are connected to each other form a connection structure at which the inlet end of the engine inlet and the beginning of the housing of the fan housing are connected to each other,
the engine inlet forms an extension structure downstream of the inlet end, extending the inlet diffuser in the axial direction, and
the extension structure extends downstream of the axial position of the connection structure in the mounted state, so that the inlet diffuser is extended in the axial direction into the area of the fan housing.

16. The engine assembly according to claim 15, wherein the extension structure is formed by a sound-absorbing panel.

17. The engine assembly according to claim 15, wherein the fan housing has a second area at the internal space surface, adjoining the fan blades of the fan in the radial direction, wherein the extension structure of the engine inlet extends in the axial direction maximally up to this second area.

18. The engine assembly according to claim 15, wherein the first attachment structure and the second attachment structure are respectively flanges and form a flange connection in the connected state.

19. The engine assembly according to claim 10, wherein the extension of the inlet diffuser in the axial direction into the area of the fan housing is formed in such a manner that the inlet diffuser has a continuously divergent cross-sectional surface extension in the transitional area between the engine inlet and the fan housing.

20. A turbofan engine comprising an engine assembly with the features of claim 10.
